(19) United States
(12) Patent Application Publication
(10) Pub. No.: US 2016/0344003 A1
(43) Pub. Date: Nov. 24, 2016

(54) STORAGE BATTERY APPARATUS, POWER CONVERSION APPARATUS, AND POWER STORAGE SYSTEM PROVIDED WITH SAME

(71) Applicant: NEC CORPORATION, Tokyo (JP)

(72) Inventors: Yousuke YAMADA, Tokyo (JP); Masahiro IMAMURA, Tokyo (JP)

(73) Assignee: NEC Corporation, Tokyo (JP)

(21) Appl. No.: 15/115,166

(22) PCT Filed: Jan. 28, 2015
(86) PCT No.: PCT/JP2015/052324

§ 371 Date: Jul. 28, 2016

(30) Foreign Application Priority Data
Jan. 29, 2014 (JP) 2014-014728

(51) Int. Cl. H01M 2/10; H01M 10/46; H02J 7/00; H01M 10/42

(52) U.S. Cl. CPC H01M 2/1077; H01M 10/425; H01M 10/46; H02J 7/0055; H01M 2010/4271; H01M 2010/4278

(57) ABSTRACT

This storage battery apparatus (201) comprises at least one storage battery module (250); at least one control module (241) configured to monitor a status of the storage battery; and a frame (210), having a plurality of supporting columns(215) for accommodating the storage battery module (250) and the control module (241). The supporting column (215) is a hollow member being at the ground potential, and a signal cable (Ls) for transmitting signals between the control modules is disposed within the supporting column (215).

### TECHNICAL FIELD

The present invention relates to storage battery apparatus, power conversion apparatus, and power storage system provided with the same, particularly to storage battery apparatus, power conversion apparatus, and power storage system provided with the same, which can reduce manufacturing cost and are advantageous for reducing installation space.

### BACKGROUND ART

Conventionally, it has been proposed to use a large storage battery apparatus which includes a plurality of storage batteries and a control unit for monitoring status of the storage batteries, to be used as, for example, a backup power source for industrial or commercial facilities, or used as a backup power source for power generating facilities.

In the storage battery apparatus, usually, power supply cables for transmitting charge or discharge electric power and signal cables for transmitting control signals are provided. Conventionally, signal cables are usually electromagnetically shielded for preventing the influence of radiation noise. Measures such as using a shielded cable as a signal cable, protecting a signal cable with a shielding member, or providing a shielding plate at the vicinity of a signal cable are adopted. Also, a configuration where power supply cables and signal cables are arranged separately is sometimes employed for reducing the influence from the power supply cables.

Patent Document 1 discloses a configuration, considered as a general electrical apparatus, where electronic apparatus unit is positioned in a housing with supporting columns, that does not necessitate a use of shielded cable by providing a cable within a metal supporting column

### REFERENCE LIST

Patent Document 1: Publication of Utility Model No. H02-084378

### SUMMARY OF INVENTION

### Technical Problem

However, according to the above reference, although general technical idea that a supporting column is used as a shielding member, it is uncertain what kind of electrical apparatus unit is housed in the housing. On the other hand, even for the large storage battery apparatus as described above, it is preferable that shielding structure for reducing manufacturing cost and advantageous for reducing installation space is adopted. Moreover, such a problem exists not only in the storage battery apparatus but also in power conversion apparatus such as a power conditioner

The present inventions have been made in view of the above problems, and its object is to provide storage battery apparatus, power conversion apparatus, and power storage system provided with the same, which can reduce manufacturing cost and are advantageous for reducing installation space.

### Solution to Problem

Storage battery apparatus of one embodiment of the present invention is as follows:
1. A storage battery apparatus, comprising:

at least one storage battery module;

at least one control module connected to the storage battery module, the control module configured to monitor a status of the storage battery; and

a frame, having a plurality of supporting columns, for accommodating the storage battery module and the control module;

wherein the supporting column is a hollow member being at the ground potential, and

a signal cable for transmitting signals between the control modules is disposed within the supporting column

### Terms

Term “storage battery module” refers to a component of a storage battery apparatus, which includes a plurality of battery units to output a predetermined electrical power.

The “signal cable” refers to, for example, a cable for transmitting control signals between devices. The signal may be analog signal or digital signal.

### Advantageous Effects of Invention

According to the present invention, by wiring a signal cable within a supporting column being at the ground potential, storage battery apparatus, power conversion apparatus, and power storage system provided with the same, which can reduce manufacturing cost and are advantageous for reducing installation space can be provided.

### BRIEF DESCRIPTION OF DRAWINGS

FIG. 1 is a front view of a storage battery apparatus according to the embodiment.

FIG. 2 is a rear view of the storage battery apparatus of FIG. 1.

FIG. 3 is a perspective view of a frame used in the storage battery apparatus of FIG. 1.

FIG. 4 is an example of a storage battery module to be housed in the frame.

FIG. 5 is another example of a storage battery module to be housed in the frame.

FIG. 6 is a perspective view for explaining a wiring of signal cable and power supply cable.

FIG. 7 is a perspective view showing an example of a column shape.

FIG. 8 is a sectional view showing several examples of the cross-sectional shape of supporting column

FIG. 9 is a view schematically showing a positional relationship of supporting column, cable, and control module.

### DESCRIPTION OF EMBODIMENT

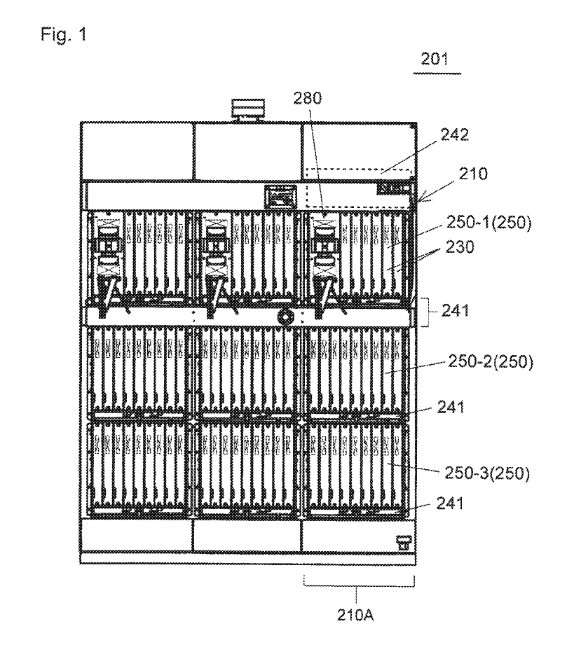

Embodiments of the present invention will be described with reference to the drawings. FIG. 1 to FIG. 3 show a specific structure of an example of the storage battery apparatus, and FIG. 4 and the others show structures schematically depicted, however, each of the technical features in the figures can be combined.

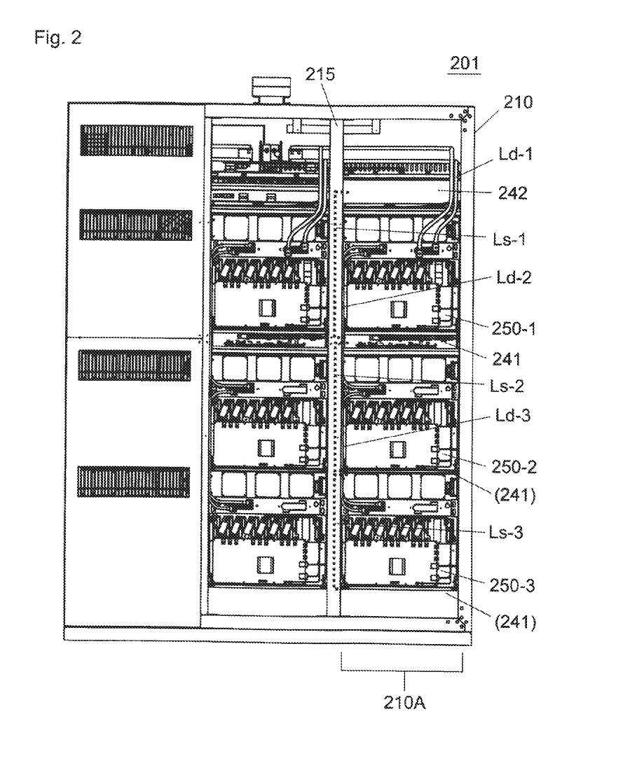

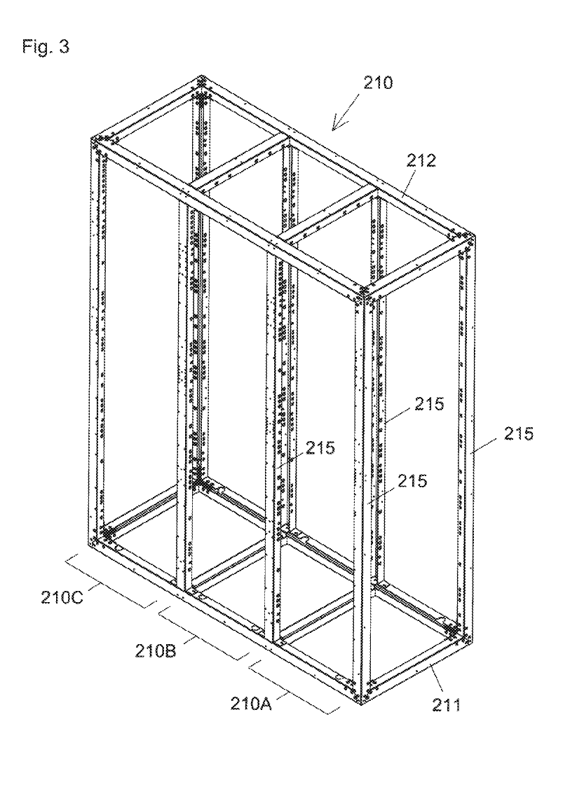

As shown in FIG. 1 and FIG. 2, a storage battery apparatus 201 has a plurality of storage battery modules 250 and a plurality of control modules 241 and 242 disposed in a frame 210 (see FIG. 3). It will be described in order below.

Frame 210, as shown in FIG. 3, as an example, has an upper frame 212 with rectangular shape viewed in vertical direction, a lower frame 211 with rectangular shape, and a plurality of supporting columns 215 connecting both frames vertically. Each of three sections 210A to 210C laterally arranged in the frame 210 are the same configuration, in principle, therefore a section 210A will be described by way of example hereinafter.

In a section 210A of the frame 210, supporting columns 215 are disposed at four corners. Supporting columns 215 may be a hollow member made of metal. In particular, columns 215 may be electrically conductive material such as steel or aluminum, for example. Cross-sectional shape of the supporting column 215 will be described later with reference to other drawings.

Storage battery modules 250-1 to 250-3 (referred to as simply “storage battery module 250”) are disposed vertically within a section 201A as can be seen in FIG. 1. Each of the storage battery module 250 is the same structure, in principle, where, by way of an example, a plurality of battery units 230 are detachably housed in a housing case 255 which has an opening at the front thereof as shown in FIG. 4. With respect to one of the three storage battery modules 250, a control device 280 is disposed instead of the battery units 230 (see FIG. 1). Storage battery modules 250 in the frame 210 are connected in series to thereby output a power corresponding to the number of battery units 230.

Although detailed illustration is omitted, the battery unit 230 may have battery cell(s) such as a lithium ion secondary battery and a housing for holding and/or accommodating it. Housing of the battery unit 230 may be, but not limited to, a vertically elongated shape as shown in FIG. 4. Further, a handle 233 may be provided on a front portion of the unit for facilitating insertion and extraction of the battery unit 230.

It is noted that the battery unit 230 is not necessarily a lithium ion secondary battery, but other type butteries such as a lead storage battery or a nickel hydrogen storage battery can be used.

As shown in FIG. 4, a first control module 241 is accommodated in a part of the housing case 255. The first control module (Battery Monitoring Unit: BMU) 241 is connected to each battery unit 230, and configured to control charging and discharging as well as to monitor the remaining amount of battery.

Other battery monitoring unit (BMU), detailed illustration is omitted, may be further disposed at an area indicated by reference numeral 241 in FIG. 1. It is noted that even when such a plurality of battery monitoring units are provided for each storage battery module 250, in the following description, these are referred to as “first control module 241”.

First control module 241 is disposed at underside of the storage battery module 250, and a second control module 242, as another battery monitoring unit, is further disposed at upperside of the topmost storage battery module 250. The second control module 242 has a function (a communication unit) of communicating with the first control module 241 and a function (another communication unit) of communicating with other device.

First and second control modules 241, 242 and the like control operations of the storage battery apparatus 201. Examples of the operation may be, but not limited to, one or more of the followings. It is noted that specific controls of operation can be performed with conventionally known various methods.
(a) supplying electric power of the storage battery module 250 with a predetermined device or system outside,
(b) charging one or more battery units 230 with receiving electric power from outside,
(c) controlling a start timing or finish timing for charge or discharge etc., and, monitoring status of each battery units 230,
(d) determining whether temperature of the one or more battery units 230 is within an accurate range,
(e) determining whether a defect in the battery unit 230 has occurred, and
(f) for a certain battery unit 230, determining how much the battery unit has been used, and determining if it is necessary to replace it based on the result, etc.

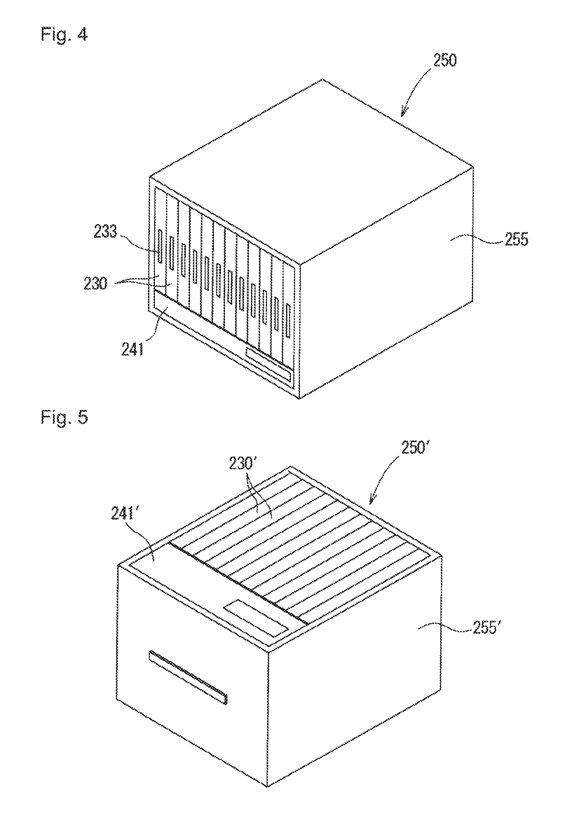

Storage battery module 250′ may be accommodated in the frame 210 as shown in FIG. 5 instead of the storage battery module 250 in FIG. 4. The storage battery module 250′ has a box-shaped housing case 255 whose upper surface side is open, in which a plurality of battery units 230 and a control module 241′ are disposed. The present invention can also be applied to a configuration in which the storage battery module 250′ is utilized.

Next, a description will be given for a wiring in the back side of the storage battery apparatus 201. It is noted that the section of the right side is shown as a “section 210A” for the sake of explanation. As shown in FIG. 2, in this example, the power supply cable Ld-3 which connects the storage battery module 250-2 in the middle and the storage battery module 250-3 in the bottom, a power supply cable Ld-2 which connects the storage battery module 250-2 in the middle to the storage battery module 250-1 in the top, and a power supply cable Ld-1 for extracting power from the storage battery module 250-1 in the top to outside. Each of the cables is arranged in substantially vertical direction for example, thereby, the three storage battery modules 250 are connected in series.

In particular, the power supply cable Ld-1 is wired so that it partially extends along the side surface of the supporting column 215 shown in right side, while the power supply cables Ld-2, Ld-3 are wired so that they partially extend along the side surface of the supporting column 215 in left side.

As schematically shown in FIG. 2, a signal cable for transmitting a predetermined signal among the control modules is disposed in substantially vertical direction, similar to the power supply cable. As signal cables in the present embodiment, a signal cable Ls-1 which connects a control module 242 in the top to a control module 241 in the middle, and signal cables Ls-2 and Ls-3 (hereinafter, referred as to “signal cable Ls” if necessary) which connect control modules 241 to each other disposed below.

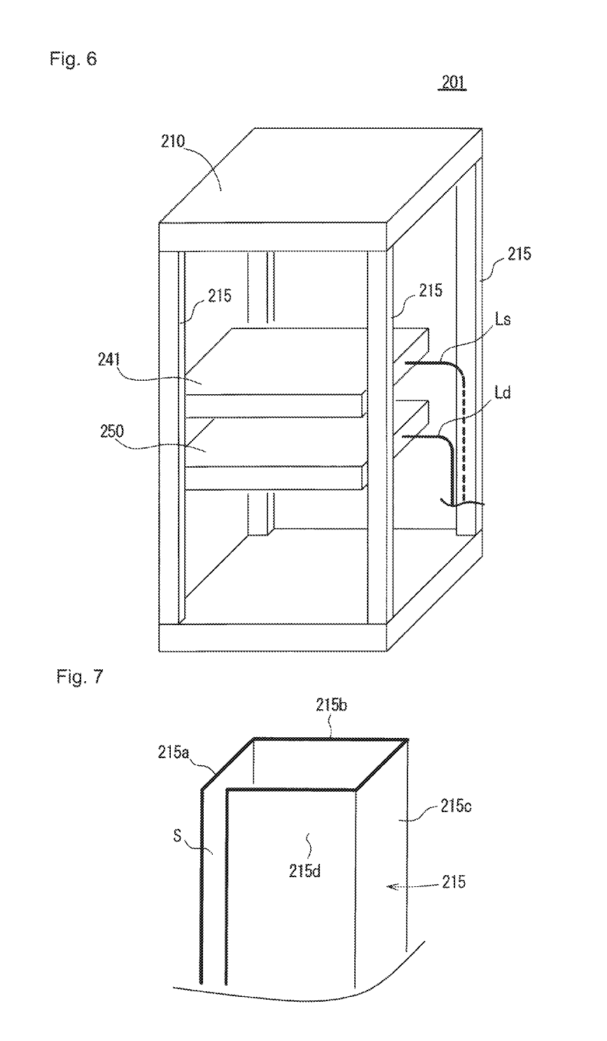

A detailed description will be given for an arrangement of the signal cable Ls with reference to FIG. 6 and FIG. 7. In FIG. 6, a storage battery module 250 disposed in the frame 210 and control modules 241 are depicted schematically. A power supply cable Ld is drawn from the storage battery module 250, and the cable is arranged along a side surface of the supporting column 215. Although the cable in this figure extends downwardly, this orientation is not an essential part of the present invention. On the other hand, a signal cable Ls is arranged so as to pass through the inside of the supporting column 215.

A variety of specific structures for supporting column 215 can be used, but by way of example the following structures may be used. Supporting column 215 shown in FIG. 7, by way of example, is made of a folded plate member having a substantially square sectional shape. Supporting column 215 may be coated. Supporting column 215 has a first side surface 215a, a second side surface 215b bending therefrom, the third side surface 215c bending therefrom and a fourth side surface 215d bending therefrom. First side surface 215a and fourth side surface 215d are not connected, so as to form an elongated slit S between the surfaces. A width of the slit S may be constant, but is not limited to.

Signal cable Ls is inserted into the supporting column 215 configured as above through the slit S. If width of the slit S is too wide, shielding performance may not be sufficiently secured. On the other hand, if it is too narrow, there may be difficulty when inserting or drawing a signal cable. Therefore, width of the slit S is preferably equal to a diameter of a signal cable to be inserted, or substantially not more than 1.5 times the diameter, or not more than 2 times the diameter, or 3 not more than times the diameter.

The Slit S may be formed over the entire length of the supporting column 215, but is not limited to. A plurality of slits S may be continuously formed along longitudinal direction of a supporting column 215. Alternatively, a slit S may be formed only on the intermediate area (in particular, an area in which a signal cable Ls is to be inserted or drawn).

Supporting columns 215 are a conductive material as described above, and are connected to ground potential to ensure shielding function. It is noted that Patent Document 1 (Utility Model H02-84378) discloses a structure where a supporting column is made by an L-shaped section member screwed to other supporting column member, however, if the L-shaped section member is coated for example, both members are not electrically connected to each other, thus grounding of the entire supporting column is not accomplished. In contrast, according to the supporting column formed of a single member as shown in FIG. 7, it can be sufficiently grounded as a whole.

Configuration as shown in FIG. 7 does not necessitate welding, therefore it is easy to manufacture and advantageous in reducing manufacturing cost.

### Other Embodiments of Supporting Column

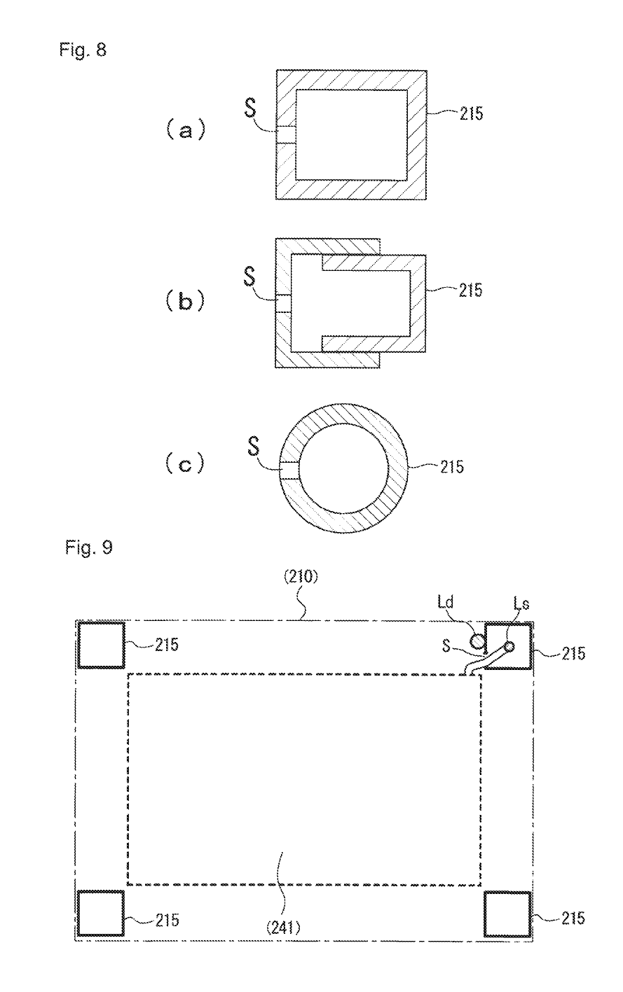

Cross-sectional shape as shown in FIG. 8 may be used. FIG. 8 (a) shows a supporting column having a rectangular cross-sectional shape made of a single member. A slit S is formed in a part thereof. Slit S may be formed at near the center of a side surface as shown in the figure; however, a slit may be formed at any position in a supporting column As a matter of course, a slit S may be formed at the vicinity of the corner as shown in FIG. 7.

FIG. 8 (b) shows a supporting column made of two members with U-shaped section. In this configuration, the members may preferably be connected to each other by for example riveting or welding. As a result, the members can be physically and electrically connected to each other, serving as a suitable electromagnetic shield member.

FIG. 8 (c) shows an example of a circular cross section. This supporting column 215 can be made by forming a slit S on a part of a commercially available hollow circular pipe.

A variety of cross-sectional shapes of the supporting column 215 can be used, however, a supporting column is preferably connected to the ground potential reliably. It is noted that several shapes of slit S can be used, as described above.

Next, description will be given for a positional relationship between the slit S and the control modules 241, 242 or the like with reference to FIG. 7. As illustrated in FIG. 9, viewing storage battery apparatus from the above, a slit S is preferably formed at the nearest corner to a control module 241 among the corners of the supporting column It is noted that “formed at the nearest corner” refers not only to a configuration where a slit S is formed at a position including a corner, but also to a configuration where a slit S is formed at a position, not including a corner, adjacent to the corner.

The structure as above can achieve reducing an influence of radiation noise, since length of non-shield cable portion from the control module 241 to the supporting column 215 is shortened.

Further, in the present embodiment, the signal cable Ls and the power supply cable Ld are wired substantially is parallel as shown in FIG. 9 (see also FIG. 2). Typically, a configuration in which signal cable Ls and power supply cables Ld are arranged in parallel in close proximity to each other tends to cause a trouble due to an influence of radiation noise from the power supply cable Ld. In contrast, according to this embodiment, since the signal cable Ls is electromagnetically shielded in the supporting column, an influence of radiation noise can be reduced.

Moreover, power supply cable Ld may be held on the side surface of the supporting column 215. According to this configuration, there is no need to provide other supporting member for power supply cable, since the supporting column 215 can (i) serve as a components member for a frame, (ii) serve as a sealing member for the signal cable and (iii) serve as a holding member for the power supply cable.

The power supply cable Ld may be positioned within a dashed line area in FIG. 9 (outline shape of the frame 210). According to this configuration, it is advantageous for downsizing an apparatus (also advantageous for to reducing installation area), since no power supply cable Ld is needed to be disposed outside the apparatus. It is noted that , however, it does not exclude a configuration where a power supply cables Ld is disposed at position other than at the above position of supporting column.

To retain a power supply cable Ld on the side surface of the supporting column, one or more holders for holding power supply cable Ld may be provided on the supporting column 215, for example. A holder, such as a member having a substantially U-shaped, elastically deformable, holding portion can be used. User can fit a cable into the U-shaped holding portion to hold the cable. Alternatively, binder such as a plastic band can be used for holding the cable.

Although only one supporting column 215 has a slit S (right side in the figure), as a matter of course, slit S may be formed on a supporting column 215 shown in left side. Further, all of the supporting columns 215 may have slits S. Each of the supporting columns 215 may be connected to grand potential. Alternatively, a configuration can be used where supporting columns 215 are electrically connected to each other, and one of the supporting columns (or other member connected thereto) is connected to the grand potential so that the other supporting columns 215 can become the same potential.

Next, a description will be given for drawing direction of signal line Ls from control module 241.

As illustrated in FIG. 6, a part of the signal line Ls from the control module 242 to the supporting column 216 preferably extends substantially in horizontal direction (including a horizontal direction and a range within +30/−30 degrees, preferably +15/−15 degrees, with respect to the horizontal direction). In this configuration of the present embodiment where storage battery modules 250 are arranged vertically, a power supply cable Ld is arranged along vertical direction in principle so as to connect storage battery modules in serial. Signal cable Ls arranged along substantially horizontal direction can extend in cross direction with respect to the power supply cable Ld , without being parallel to each other, even if the power supply cable Ld is present in the vicinity of the signal cable. As a result, electric field coupling is less likely to occur, and influence by radiation noise can be reduced.

According to the storage battery apparatus of the present embodiment as described above, there is no need to take measures such as using a shielded cable, using a noise shielding member, or separating a signal cable from a cable that might cause noise, since the signal cable Ls is in the state of being electromagnetically shielded disposed in a ground potential supporting column 215. Therefore, it is possible to simplify the structure of the device and reduce manufacturing cost. Moreover, the signal cable Ls can be electromagnetically shielded more reliably, since the supporting column 215 is at the ground potential.

### Other Embodiments

Although the embodiments of the present inventions have been described above, the present invention is not intended to be limited to the disclosed configurations. The embodiments can be changed freely without departing from the scope of the present invention.

For example, although the storage battery apparatuses are described by way of example in the above embodiments, the present invention may be applied to a power converter device (power conditioner) connected to the storage battery apparatus. Power conversion apparatus, comprising for example a frame for accommodating control device, a DC-AC converter disposed in the frame, and at least one control module for controlling the DC-AC converter may be used.

Signal cable may be, then, disposed within a supporting column of the frame, at the ground potential, so as to achieve the electromagnetically shielding against radiation noise from the power supply cable. Although detailed description will be omitted, even in this case where the present invention applied to a power conversion apparatus, technical features disclosed in the above embodiments are intended to be combined as appropriate.

### REMARKS

The present description discloses the following inventions:
1. A storage battery apparatus (201), comprising:

at least one storage battery module (50);

at least one control module (241, 242) connected to the storage battery module, the control module configured to monitor a status of the storage battery; and

a frame (210), having a plurality of supporting columns, for accommodating the storage battery module and the control module;

wherein the supporting column is a hollow member being at the ground potential, and

a signal cable for transmitting signals between the control modules is disposed within the supporting column
2. The storage battery apparatus as described above, further comprising a power supply cable, wherein the signal cable and the power supply cable are arranged substantially in parallel (including both completely parallel and intersection angle within 15 degree).
3. The storage battery apparatus as described above, wherein the power supply cable is supported on outside (outer surface) of the supporting column in which the signal cable is disposed.
4. The storage battery apparatus as described above, wherein sectional shape of the supporting column is square and the supporting column comprises a slit extending (at least partially) along a longitudinal direction of the supporting column, through which the signal cable can be inserted or drawn out.
5. The storage battery apparatus as described above, wherein the supporting column is made of a plate member, the supporting column including a first side surface, a second side surface bending therefrom, a third side surface bending therefrom, and a forth side surface bending therefrom, and

wherein the slit (S) is formed between the first side surface and the forth side surface which are not connected to each other.
6. The storage battery apparatus as described above, wherein each of the four supporting columns is disposed at an outer position of corners of the control module (241, 242) in a view from the above, and the slit is positioned at a corner nearest the control module (241, 242) in a view from the above.
7. The storage battery apparatus as described above, wherein a plurality of the storage battery modules (250) and a plurality of the control modules (241, 242) are disposed in vertical direction, and wherein the power supply cable is a cable for connecting a storage battery module to other storage battery module.
8. A power conversion apparatus, comprising:

an AC-DC converter for converting an alternating current to a direct current and a direct current to an alternating current;

at least one control module electrically connected to the AC-DC converter; and

a frame, having a plurality of supporting columns, for accommodating the AC-DC converter and the control module;

wherein the supporting column is a hollow member being at the ground potential, and a signal cable is disposed within the supporting column
9. A storage battery system, comprising:

the storage battery apparatus as described above; and

a power conversion apparatus connected to the storage battery apparatus.

### REFERENCE NUMERAL LIST

201 STORAGE BATTERY DEVICE
210 FRAME
211 and 212 FRAME
210A to 210C SECTION
215 SUPPORTING COLUMN
230 BATTERY UNIT
241 and 242 CONTROL MODULE
250 STORAGE BATTERY MODULE
Ls SIGNAL CABLE
Ld POWER SUPPLY CABLE
S SLIT

1. A storage battery apparatus, comprising:
at least one storage battery module;
at least one control module connected to the storage battery module, the control module configured to monitor a status of the storage battery; and
a frame, having a plurality of supporting columns, for accommodating the storage battery module and the control module;
wherein the supporting column is a hollow member being at the ground potential, and
a signal cable for transmitting signals between the control modules is disposed within the supporting column.

2. The storage battery apparatus according to claim 1, further comprising a power supply cable, wherein the signal cable and the power supply cable are arranged substantially in parallel.

3. The storage battery apparatus according to claim 2, wherein the power supply cable is supported on outside of the supporting column in which the signal cable passes though.

4. The storage battery apparatus according to claim 1, wherein sectional shape of the supporting column is square, and the supporting column comprises a slit extending along a longitudinal direction of the supporting column, through which the signal cable can be inserted or drawn out.

5. The storage battery apparatus according to claim 4, wherein the supporting column is made of a plate member, the supporting column including a first side surface, a second side surface bending therefrom, a third side surface bending therefrom, and a forth side surface bending therefrom, and
wherein the slit is formed between the first side surface and the forth side surface which are not connected to each other.

6. The storage battery apparatus according to claim 4, wherein each of the four supporting columns is disposed at an outer position of corners of the control module in a view from the above, and the slit is positioned at a corner nearest the control module in a view from the above.

7. The storage battery apparatus according to claim 1, wherein a plurality of the storage battery modules and a plurality of the control modules are disposed in vertical direction, and wherein the power supply cable is a cable for connecting a storage battery module to other storage battery module.

8. A power conversion apparatus, comprising:
an AC-DC converter for converting an alternating current to a direct current and a direct current to an alternating current;
at least one control module electrically connected to the AC-DC converter; and
a frame, having a plurality of supporting columns, for accommodating the AC-DC converter and the control module;
wherein the supporting column is a hollow member being at the ground potential, and a signal cable is disposed within the supporting column.

9. A storage battery system, comprising:
the storage battery apparatus according to claim 1; and
a power conversion apparatus connected to the storage battery apparatus.
